(19) United States
(12) Patent Application Publication
(10) Pub. No.: US 2017/0035628 A1
(43) Pub. Date: Feb. 9, 2017

(54) PATIENT SUPPORT

(71) Applicant: Stryker Corporation, Kalamazoo, MI (US)

(72) Inventors: Brandon David Naber, Portage, MI (US); Chad Conway Souke, Portage, MI (US); Clifford Edwin Lambarth, Portage, MI (US); Jason James Wroblewski, Kalamazoo, MI (US)

(21) Appl. No.: 14/998,028

(22) Filed: Jul. 7, 2014

(51) Int. Cl. A61G 1/04; A61G 1/02; A61G 1/013

(52) U.S. Cl. CPC A61G 1/04; A61G 1/013; A61G 1/0212; A61G 1/0262; A61G 2203/14; A61G 2203/16; A61G 2203/32; A61G 2203/40; A61G 2203/44; A61G 2205/60

(57) ABSTRACT

A patient support includes bearings, a litter frame supported relative to the bearings, an elevating mechanism for changing the elevation of the litter frame relative to the bearings at an elevating mechanism speed, and a user interface operable to vary the elevating mechanism speed.

### TECHNICAL FIELD AND BACKGROUND OF THE INVENTION

The present invention relates to a patient support, such as an emergency cot, with a patient support surface and a lifting mechanism for raising or lowering the patient support surface.

### SUMMARY OF THE INVENTION

According to one embodiment, a patient support includes bearings, a litter frame supported relative to the bearings, an elevating mechanism for changing the elevation of the litter frame relative to the bearings at an elevating mechanism speed, and a user interface operable to vary the elevating mechanism speed.

In one aspect, the user interface is operable to generate a first control input to the elevating mechanism to change the elevation of the litter frame at a first speed and operable to generate a second control input to the elevating mechanism to change elevation of the litter frame at a second speed greater than the first speed.

In another aspect, the user interface is operable to generate a first control input to the elevating mechanism to elevate the litter frame at a first speed when used in combination with a second control input to the elevating mechanism, with the first control input and the second and the control input changing elevation of the litter frame to a second speed greater than the first speed.

In yet another aspect, the user interface includes a variable control mechanism, which varies the elevating mechanism speed based on the variation of the input of the user interface. For example, the variable control mechanism may include a joy stick, a track ball or a dial.

According to another embodiment, a patient support includes bearings, a litter frame supported relative to the bearings, an elevating mechanism for changing the elevation of the litter frame relative to the bearings, the elevating mechanism changing the elevation of the litter frame at an elevating mechanism speed, a sensor configured to detect when the cot is in a loading/unloading area of a conveyance apparatus, and a controller in communication with the sensor, which is configured to control the elevating mechanism speed based on input from the sensor.

In one aspect, the sensor comprises an RFID reader, a proximity sensor, a hall sensor or a reed sensor. For example, the sensor may be supported by the litter frame.

In a further aspect, the litter frame includes a load wheel with a sensor coupled to the load wheel. The sensor is configured to detect a load on the load wheel, for example, to detect when the load wheel is in contact with the conveyance apparatus.

According to yet another aspect, the litter frame may include a safety bar, with a sensor coupled to the safety bar and configured to detect a load on the safety bar, for example, to detect when the safety bar is engaged with the conveyance apparatus.

In yet another aspect, the sensor is configured to detect an interface with or close proximity to a cot fastener or loading system of the conveyance apparatus.

According to yet another embodiment, a patient support include bearings, a litter frame supported relative to the bearings, an elevating mechanism for changing the elevation of the litter frame relative to the bearings, a sensor configured to detect vertical motion of (i) the bearings, (ii) the litter frame, or (iii) the elevating mechanism, and a controller in communication with the sensor, which is configured to operate the elevating mechanism at a selected speed based on the input from the sensor.

In one aspect, the controller changes the speed of the elevating mechanism when the sensor detects vertical motion of the litter frame. For example, the sensor may comprise an accelerometer.

According to yet another embodiment, a patient support includes bearings, a litter frame supported relative to the bearings, an elevating mechanism for changing the elevation of the litter frame relative to the bearings, a sensor configured to measure the distance or proximity of the patient support or the litter frame to a reference, and a controller in communication with the sensor, with the controller configured to control the elevating mechanism speed based on input from the sensor.

In one aspect, the sensor measures the distance of the patient support to a conveyance apparatus. For example, the controller may be configured to change the elevating mechanism speed when the sensor determines that the patient support is in close proximity to the conveyance apparatus.

In another aspect, the sensor measures the distance of the base frame to the ground, with the controller configured to change the elevating mechanism speed based on the distance measured by the sensor.

In any of the above, the elevating mechanism may exert a force on the litter deck with the controller limiting the force of the elevating mechanism based on the elevating mechanism speed.

In any of the above, the bearings may comprise wheels.

In any of the above, the patient support may further include a base with the base supporting the bearings.

In yet another embodiment, a patient support includes bearings, a litter frame supported relative to the bearings, an elevating mechanism for changing the elevation of the litter frame relative to the bearings at an elevating mechanism speed, a sensor configured to measure the weight of an occupant on the patient support, and a controller in communication with the sensor, which is configured to adjust the elevating mechanism speed based on the weight measured by the sensor.

In one aspect, the sensor comprises and RFID reader, a proximity sensor, a hall sensor or a reed sensor.

In any of the above, the patient support may comprise an emergency cot.

According to yet another embodiment, a method of controlling the speed of an elevation mechanism of a patient support includes sensing an input or parameter associated with the patient support, and adjusting the speed of the elevating mechanism based on the sensed parameter.

In one aspect, the sensing includes sensing a user input at the patient support.

In another aspect, the sensing includes sensing the proximity of the patient support to a conveyance apparatus, such as an ambulance.

According to yet another aspect, the sensing includes sensing the weight of an occupant on the patient support.

According to yet another aspect, the sensing includes sensing the motion of one or more components of the patient support.

Accordingly, a patient support of the present invention may provide enhanced control over the raising or lowering of the litter frame, which supports the patient support surface. These and/or other features and advantages will be appreciated from the description of the drawings and detailed description of the preferred embodiments which follow.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DESCRIPTION OF THE DRAWINGS

FIG. 1 is a side view of a patient support adjacent a rear opening of a vehicle as it being loaded into a conveyance apparatus, such as an ambulance;

FIG. 2 is a similar view to FIG. 1 illustrating the patient support supported at the head end of the patient support by the conveyance apparatus and lifted by an emergency medical person at the foot end of the patent support;

FIG. 3 is a similar view to FIGS. 1 and 2 showing the emergency medical person lifting the bearings of the patient support relative to the litter frame;

FIG. 4 is a similar view to FIGS. 1-3 illustrating the patient support moved into the compartment of the conveyance apparatus;

FIG. 5 is a schematic drawing of the control system of the patient support;

FIG. 5A is another schematic drawing of the control system of the patient support;

FIG. 5B is a schematic drawing of a second embodiment of the control system;

FIG. 5C is a schematic drawing of a third second embodiment of the control system;

FIG. 5D is a schematic drawing of a fourth second embodiment of the control system;

FIG. 6 is a similar view to FIG. 1 illustrating a signal communicated between the patient support and the conveyance apparatus;

FIG. 7 is a side view of another embodiment of a patient support;

FIG. 8 is a side view of a third embodiment of a patient support;

FIG. 9 is a side view of a fourth embodiment of a patient support;

FIG. 10 is a flow chart illustrating a method of controlling the speed of the patient support;

FIG. 11 is a flow chart of a second method of controlling the speed of the patient support;

FIG. 12 is a flow chart of a third method of controlling the speed of the patient support; and

FIG. 13 is a flow chart of a fourth method of controlling the speed of the patient support.

### DETAILED DESCRIPTION OF THE EMBODIMENTS

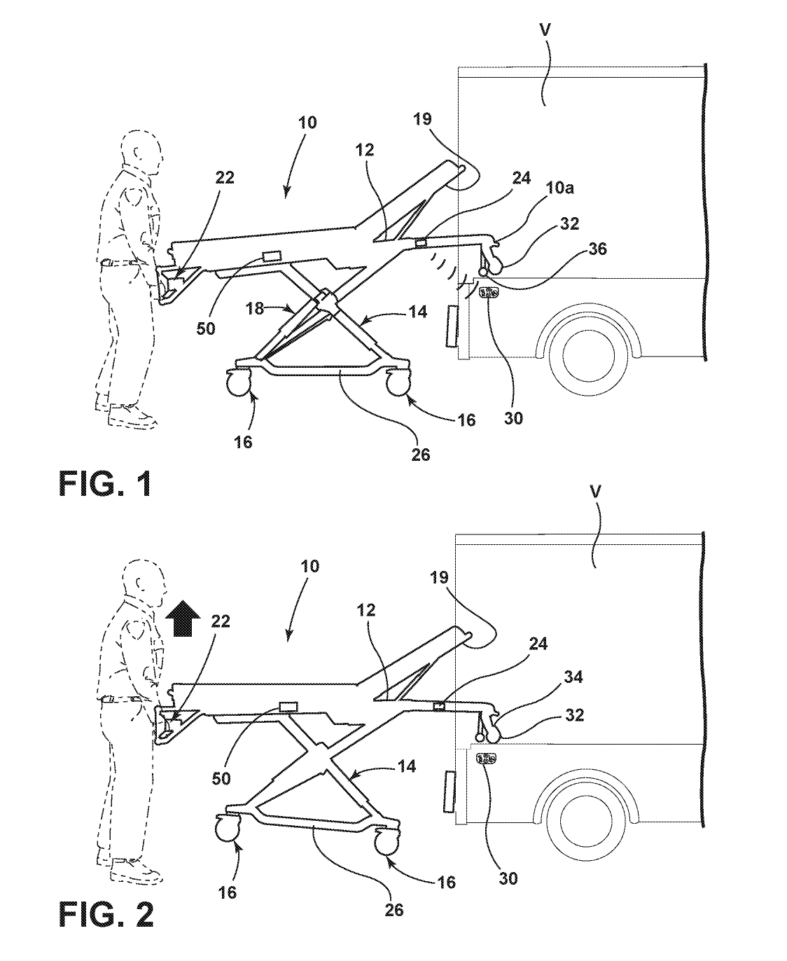

Referring to FIG. 1, the numeral 10 generally designates a patient support. In the illustrated embodiment, patient support 10 comprises an ambulance cot; however, it should be understood that the features of support 10 may also be employed in other patient supports, such as stretchers or beds, for example. An exemplary construction of the ambulance cot is disclosed U.S. Pat. No. 7,398,571, which is commonly assigned to Stryker Corporation, Kalamazoo, Mich., and which is incorporated by reference herein in its entirety. As more fully described below, patient support 10 is adapted to control extension and retraction speeds of its elevating mechanism based on a parameter, including based on an operation being performed.

Referring again to FIG. 1, patient support 10 includes a litter frame 12, a lifting or elevating mechanism 14, and plural bearings 16. Elevating mechanism 14 supports litter frame 12 on bearings 16 and includes one or more actuators 18 for raising or lowering the litter frame relative to bearings 16. Suitable actuators include linear actuators, such as servo motors, hydraulic cylinders or a combination thereof. In the illustrated embodiment, elevating mechanism 14 includes a pair of X-frames, which are extended or contracted by actuator(s) 18 to thereby raise or lower litter frame 12, which supports a litter deck 19 for supporting a patient.

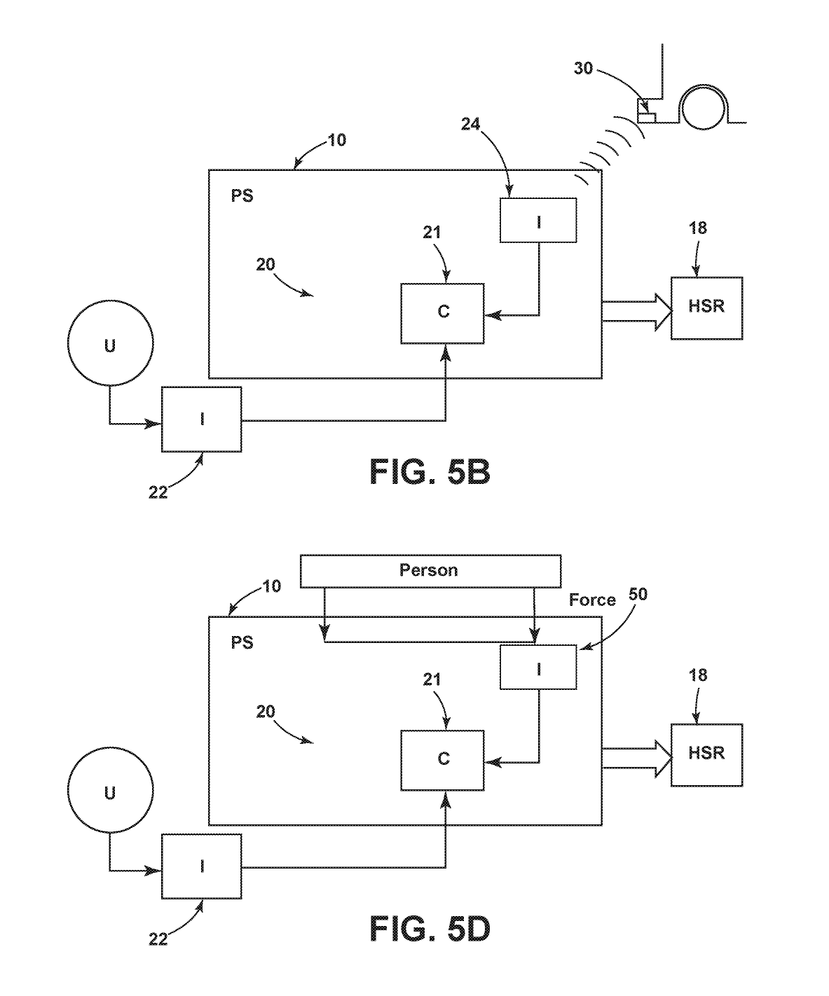

To control actuators 18, patient support 10 includes a control system 20 (see FIG. 5). Control system 20 includes a controller or control board 21 and a user interface 22, which may be mounted, for example, at the foot end of the patient support, such as shown in FIG. 1. User interface 22 allows an attendant to control actuator(s)18 to raise and lower bearings 16 once the head end of support 10 is supported, for example, at a conveyance apparatus, such as at the rear opening of an ambulance vehicle V.

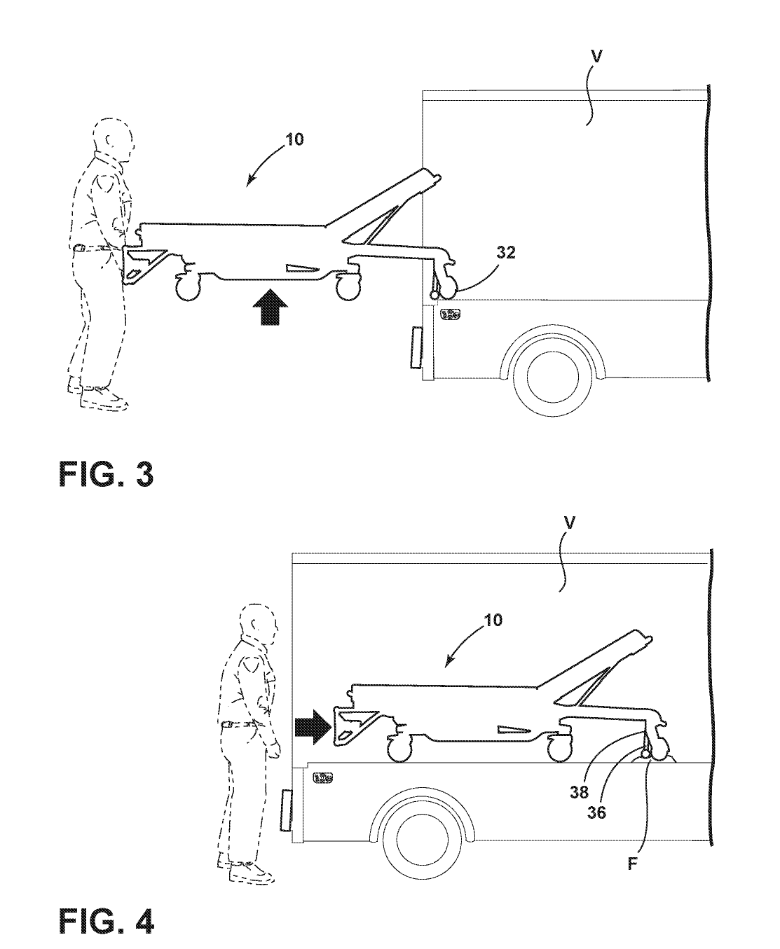

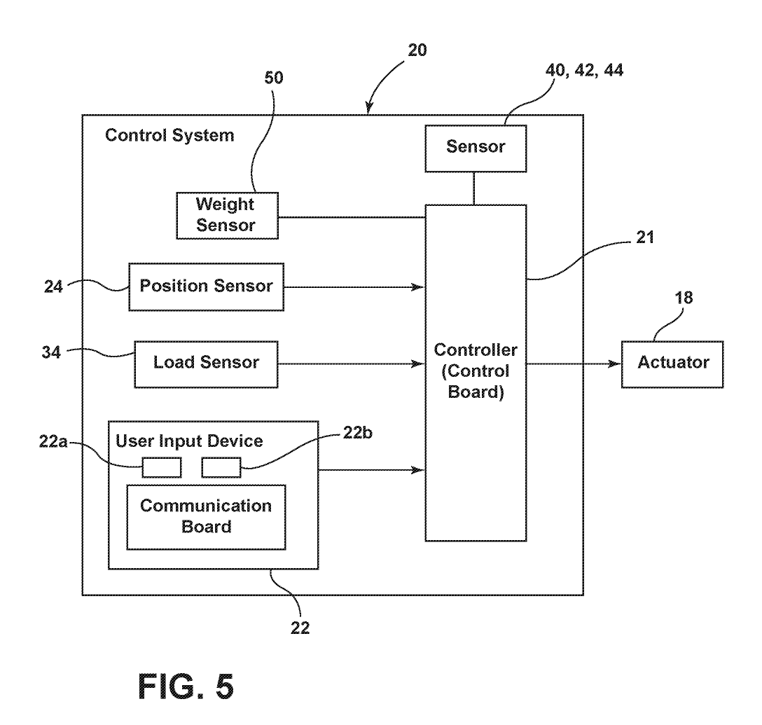

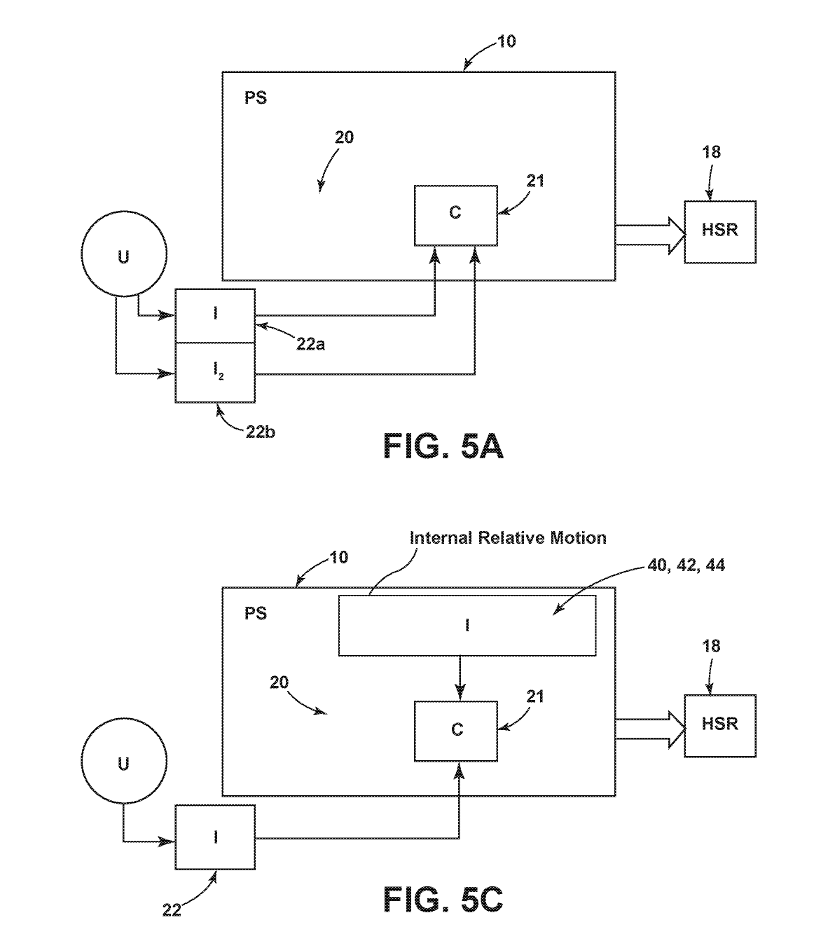

Referring to FIGS. 2-4, once the head end of support 10 is supported in the vehicle V, an attendant or emergency medical services (EMS) personnel can support the foot end of the support 10 and, thereafter, raise the bearings relative to the litter frame so that the patient support is in a compact configuration for loading into the vehicle, such as shown in FIGS. 3 and 4. Similarly, when patient support 10 is removed from the vehicle, the attendant may grab the foot end of the support 10 to pull the foot end of the support from the vehicle until the bearings are moved outside the vehicle (such as shown in FIG. 3) at which point the bearings 16 may be lowered so that the full weight of the support can then supported by the bearings on the ground.

Referring to FIGS. 5 and 5A, optionally user interface 22 includes one or more user inputs 22a, 22b to control the lift mechanism speed. For example, the user inputs may include two inputs—a first, slow speed switch and a second switch for a second, faster speed to allow fast operation/movement of the lift mechanism, which may be desired in emergency situations. Alternately, the user inputs may comprise a single user input that is used for all lift operations, with the second user input, for example, a turbo button, being activated to indicate to the controller to operate the lift actuator(s) at a faster speed. The faster speed may be desirable when the cot is loaded into and unloaded from the vehicle. For a full retract or extend of the lift mechanism, a “slow” speed typically ranges from about 1-3 seconds, and a “fast” speed ranges from about 5-8 seconds.

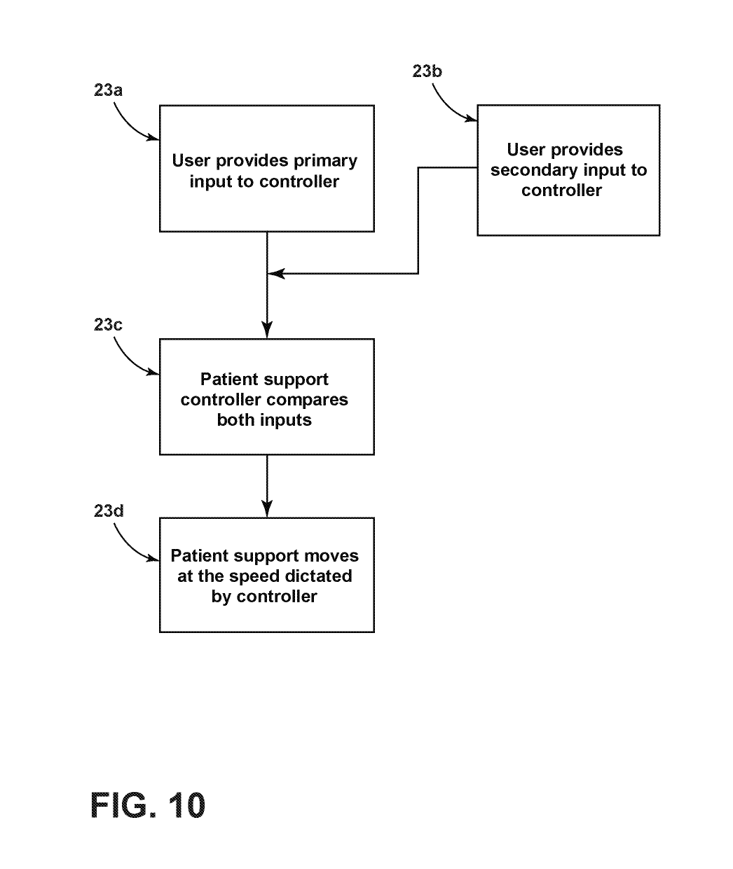

For example, referring to FIG. 10, a user may provide a primary input (e.g. a lift signal to instruct the controller to drive or operate the lift mechanism) to the controller (23a). The user then may provide a secondary input (e.g. a fast or slow lift signal) to the controller (23b). The patient support controller 21 then compares both inputs (23c), and then moves the lift mechanism at the speed dictated by controller (23d).

Thus, user interface 22 is operable to generate a first control input to controller 21, which generates a signal to the elevating mechanism to change the elevation of the litter frame at a first speed and then is operable to generate a second control input to the elevating mechanism to change elevation of the litter frame at a second speed greater than the first speed. As described above, this may in the form of providing two inputs, such as switches, with the user selecting between the two switches to select the speed, or may be provided in the form of a single input (e.g. switch) with an additional input, such as a turbo button, being actuated at the same time as the single input. Optionally, the first or second user input may include a variable control mechanism, which varies the elevating mechanism speed based on the variation of the input at the user input. For example, the variable input may comprise a joy stick, a track ball, a dial, a load cell, a variable push button, dual buttons, an auxiliary button, or a pressure sensitive switch.

Optionally, referring to FIGS. 5 and 5B, patient support 10 may include a sensor 24 that detects when patient support is being loaded into or unloaded from a vehicle. The location of the sensor may vary. For example, sensor 24 may be located on the litter frame. Suitable sensors include RFID readers, for example, that detects an RFID tag 30 at the vehicle, or a proximity sensor or a hall sensor or a reed sensor or the like.

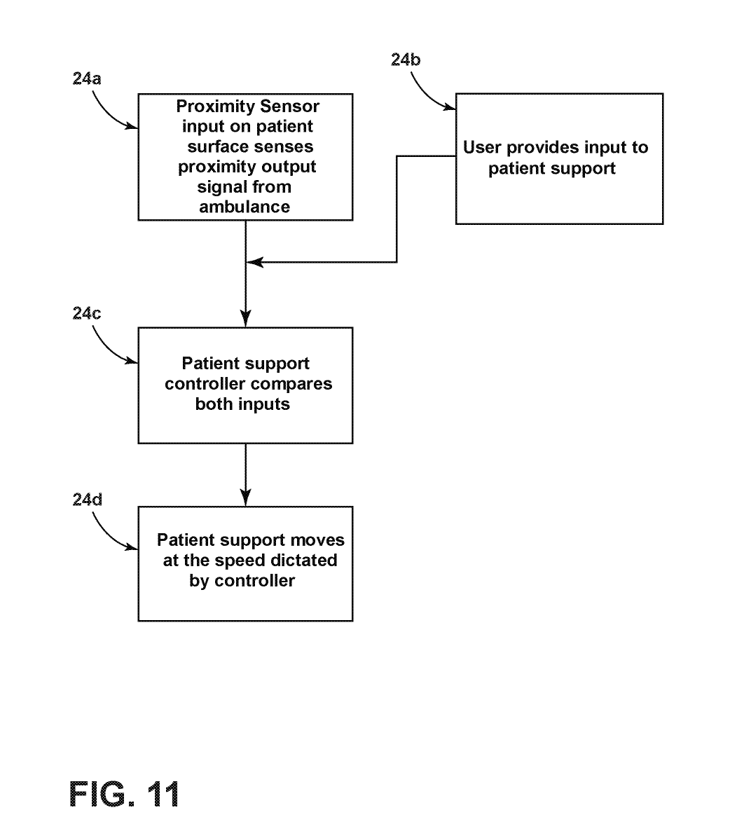

Referring to FIG. 11, the sensor input on the patient support senses a proximity output signal from, for example, an ambulance (24a). When a user then provides a control input to raise the lift mechanism at the patient support (24b), the patient support controller compares both inputs (24c). The patient support then moves the lift mechanism at the speed dictated by controller (24d).

Alternately, sensor 24 may sense or detect proximity to or an interface with a fastener, a loading system, or a safety hook. For examples of suitable fasteners, loading systems or safety hooks, reference is made herein to U.S. Patent Nos. U.S. Pat. No. 7,887,113, and U.S. Pat. No. 7,478,855, which are commonly owned by Stryker Corporation of Kalamazoo, Mich., and which are incorporated by reference herein in their entireties.

Referring to FIGS. 1-4, bearings 16 are optionally supported on a base frame 26, which provides a mount for the lower ends of the lifting mechanism 14. As noted above, patient support 10 may also include a sensor for detecting when the support is in a loading/unloading area of the conveyance apparatus such as vehicle V. For example, sensor 24 may be mounted to the litter frame, as noted above, or may be mounted to base 26, or litter deck 19. Therefore, when an attendant wheels the support 10 in close proximity to the vehicle, for example a distance such that the head end of the patient support 10 is extended into the rear opening of and supported by the vehicle V (for example, within 0.25 to 1.5 feet), control system 20 may be configured to change the elevating mechanism speed. As noted above, control system 20 is in communication with the user input and may, therefore, be configured to change the elevating mechanism speed based on the input from the user input as well as the proximity to the vehicle. For example, when sensor 24 detects that the cot is in close proximity to the vehicle and the user has input a lift signal to the controller, the controller will adjust the speed of actuator 18 so that elevating mechanism 14 will quickly lift bearings 16 and/or base frame 26 relative to the litter frame so that the patient support 10 can be quickly loaded into the vehicle V.

To facilitate loading and unloading of patient support 10, head end 10a of patient support 10 may include a load wheel 32. In this manner, when patient support 10 is aligned at the rear opening of vehicle V, the attendant may push the patient support 10 into the rear opening so that the load wheel 32 engages the deck of the vehicle V, thereby allowing the vehicle to support at least a portion of the weight of the patient support 10. Optionally, patient support 10 may in addition or alternately include a load sensor 34, for example, at the load wheel 32, which detects when the load wheel is contact, for example, with the deck of the vehicle V. Sensor 34 may also be in communication with controller 21, which may then be configured to evaluate the signal from sensor 34 (e.g. compare the signal to a stored value) to determine whether the load wheel is sufficiently loaded to indicate that support 10 is at least partially supported by the vehicle and then actuate actuator 18 to initiate the raising of bearings 16 at the desired speed, either based on the sensor's input alone or based on the combination with the input from user input(s) 22a, 22b and/or based on signals from sensor 24.

Optionally, patient support 10 may also include a safety bar 36 with a sensor 38 coupled to the safety bar so that sensor 38 can detect when safety bar 36 is engaged at the vehicle V, for example, by a cot fastener F (see FIG. 4). Similar to as noted above, sensor 38 may be configured to detect an interface with or in proximity to the cot fastener or a loading system of the vehicle. Thus, controller 21 may control the speed of the elevating mechanism based on user input as well as signals from sensor 38 alone or in combination with any of the above mentioned sensors.

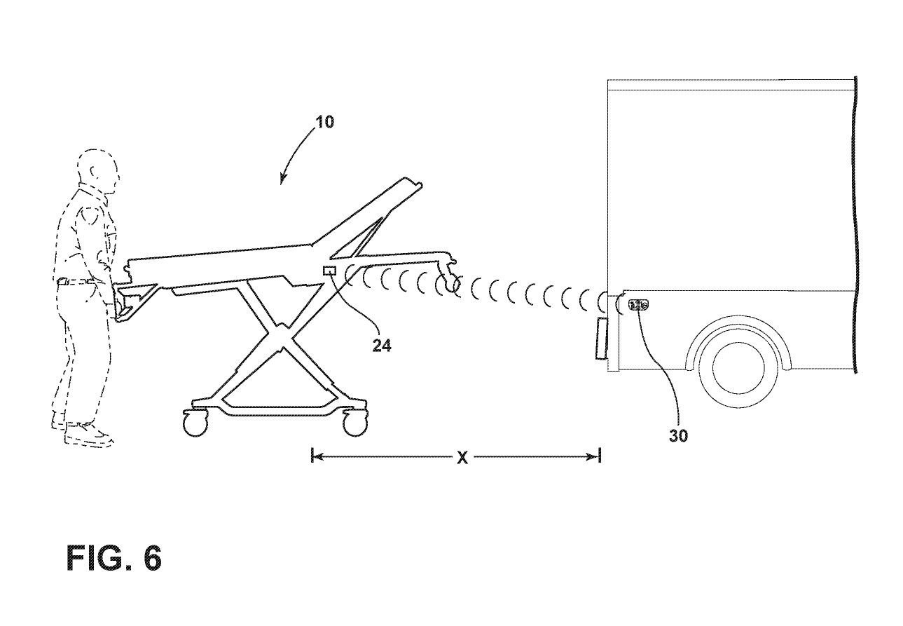

Referring to FIG. 6, as noted above, sensor 24 may be configured to detect the distance or proximity of the patient support to a reference, such as vehicle V. For example, sensor 24 may be configured to measure a distance X of patient support 10 to vehicle V, with controller 21 then comparing the measured distance to a stored value. When controller 21 detects that distance X is less than the stored value, controller 21 may then be configured to vary the speed of the elevating mechanism as noted above. For example, controller 21 may be configured to change the elevating mechanism when controller 21 receives the user input noted above and when sensor 24 determines that the patient support is, for example, within 0.25 to 3.0 feet of vehicle V.

Alternately, sensor 24 may be configured to measure the distance of the bearings and/or base frame 26 to the ground, with controller 21 configured to change the elevation mechanism speed based on the distance measured by the sensor. For example, if the sensor measures a value less than a set threshold, the elevation mechanism may be controlled to operate in response to the user input only at a slow speed. When the measured distance becomes greater than the threshold value, for example, controller 21 may then operate the lift mechanism in response to the user input at a faster speed. For example, it may be desirable for the elevation mechanism to be incapable of lifting or lowering the base or bearings at high speed, which could mitigate the risk of the litter being lifted or lowered if the support accidentally contacts an object, such as the ambulance bumper when unloading the cot.

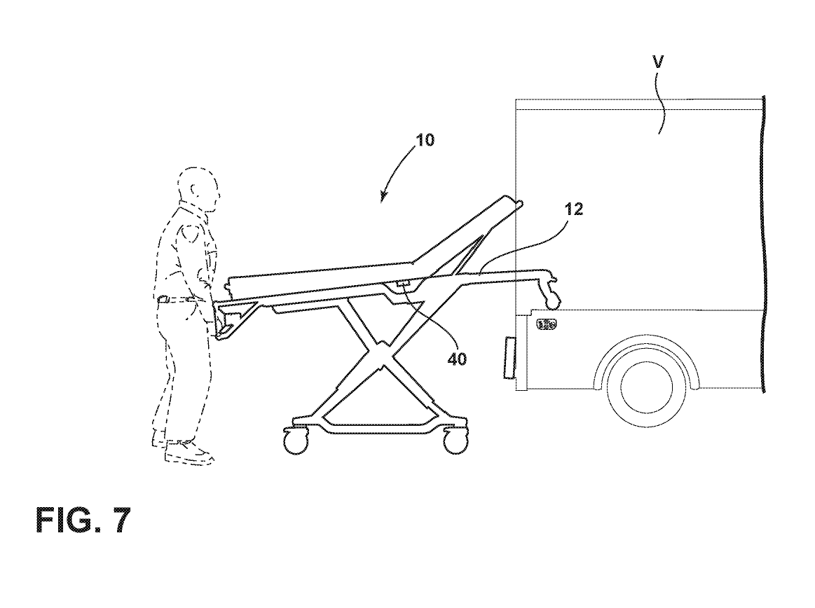

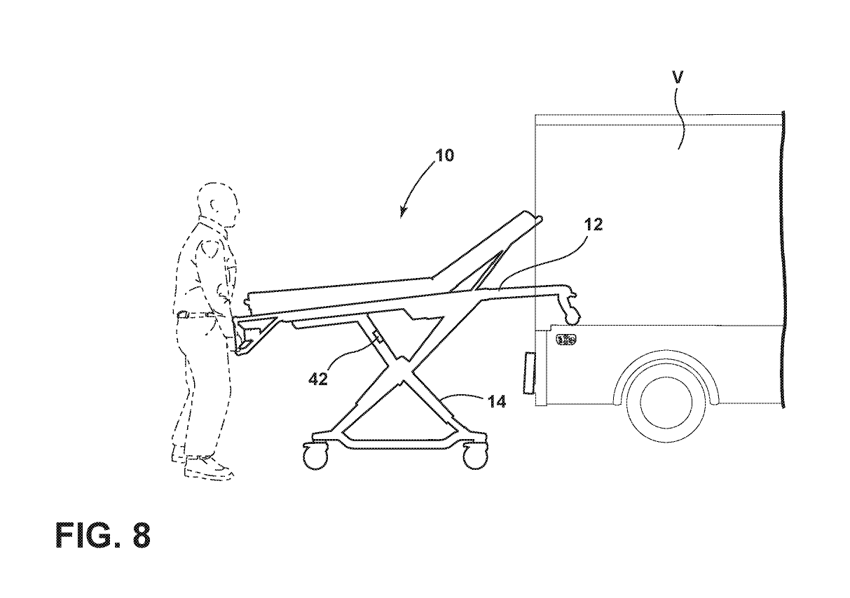

According to yet another embodiment, patient support 10 may include a sensor to detect the vertical motion of the bearings, the litter frame, or the elevating mechanism. For example, referring to FIGS. 5, 5C and 7, support 10 may include a sensor 40 mounted to the litter frame 12 that detects the motion of the litter frame relative to the bearings. Referring to FIG. 8, a sensor 42 may be alternately mounted to lift mechanism 14 to detect the vertical motion of the lift mechanism relative to the litter frame. Alternately, support 10 may include a sensor 44 mounted to either bearings 16 or base frame 26 to detect the motion of the bearings or base frame relative to the litter frame.

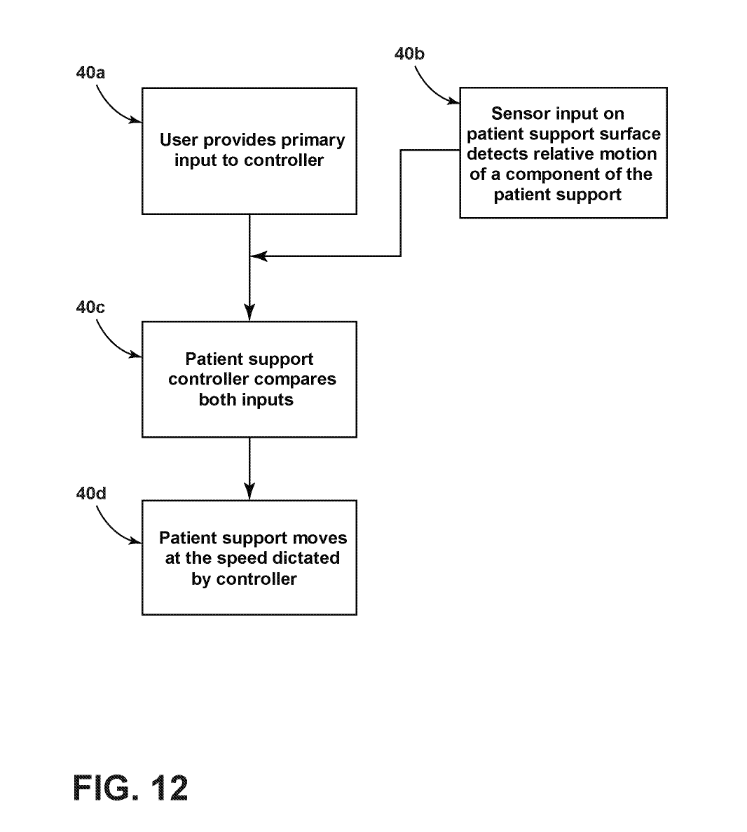

Referring to FIG. 12, a user provides primary input (e.g. a lift signal) to controller (40a) to operate the lift mechanism. The sensor input on the patient support detects relative motion of a component of the patient support (40b), e.g., the lifting mechanism, the bearings or base or the litter frame. The patient support controller then compares both inputs (40c), and then the patient support drives the lift mechanism at the speed dictated by controller (40d).

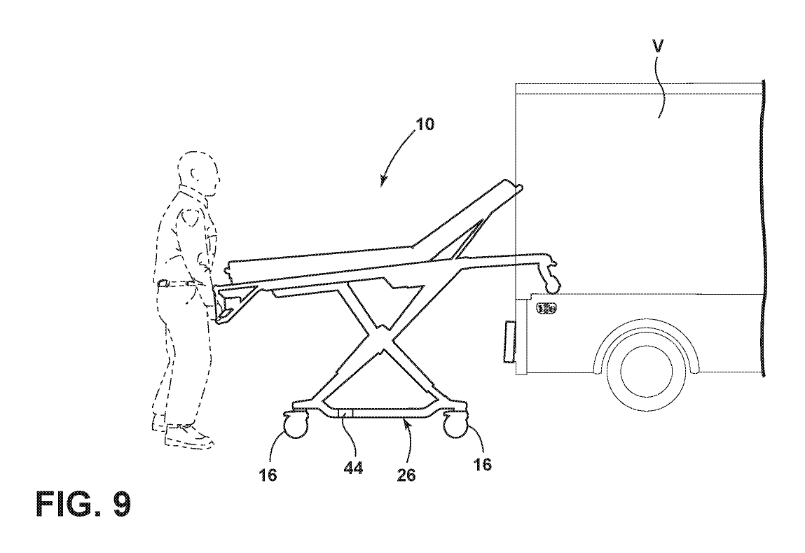

In any of the embodiments illustrated in FIGS. 7-9, the control system may be in communication with the sensor (40, 42, or 44) and configured to operate the elevating mechanism at a desired speed based on the input from respective sensor (40, 42 or 44) (FIG. 5c). For example, controller 21 of the control system 20 may change the speed of the elevating mechanism, for example by increasing the speed, when the sensor detects vertical motion of the litter frame or the elevating mechanism. Similarly, controller 21 may change the speed of the elevating mechanism, for example by increasing the speed, when the sensor 44 detects the vertical motion of the bearings and/or base. For example, a suitable sensor includes an accelerometer.

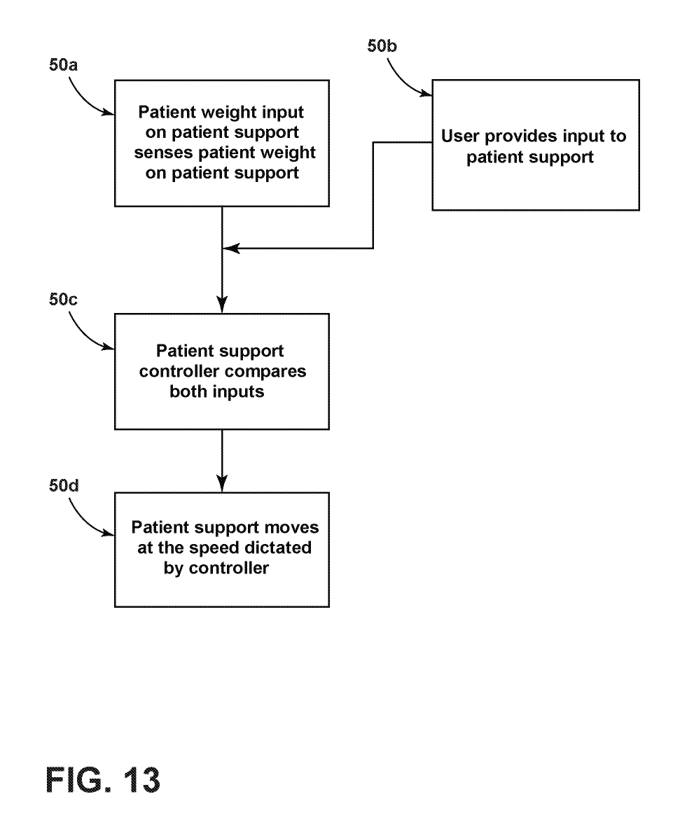

According to yet another embodiment, patient support 10 may include one or more sensors 50 (FIGS. 1. 2, 5 and 5D), for example load cells, to measure the weight of an occupant on patient support 10. As shown in FIG. 5D, controller 21 may be in communication with the sensor(s) 50, with controller 21 configured to adjust the elevating mechanism speed based on the weight measured by the sensor 50. For example, referring to FIG. 13, when controller 21 senses the weight of the patient on the patient support (50a) and the user provides an input (e.g. a lift signal to instruct the controller to drive or operate the lift mechanism) to the patient support controller (50b), controller 21 compares both inputs (50c), and then varies the control of the speed of the lift mechanism or elevating mechanism based on the presence or absence of a person on the patient support 10 as dictated by the controller (50d).

Therefore, the patient support is configured to control the speed of its elevation mechanism by sensing an input from a user, sensing another input or parameter associated with the patient support, and then adjusting the speed of the elevating mechanism based on the input from the user in combination with the other input or sensed parameter. For example, as noted above, the parameter may include sensing a second user input at the patient support, sensing the proximity or distance of the patient support to a conveyance apparatus, such as an ambulance vehicle, or sensing the weight of an occupant on the patient support. Further, the method may include sensing the motion of one or more components of the patient support and then adjusting the speed of the elevating mechanism based on the motion.

It should be understood that alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

We claim:

1. A patient support comprising:
bearings;
a litter frame supported relative to the bearings;
an elevating mechanism for changing the elevation of the litter frame relative to the bearings at an elevating mechanism speed; and
a user interface operable to vary the elevating mechanism speed.

2. The patient support according to claim 1, wherein the user interface is operable to generate a first control input to the elevating mechanism to change the elevation of the litter frame at a first speed, and operable to generate a second control input to the elevating mechanism to change the elevation of the litter frame at a second speed greater than the first speed.

3. The patient support according to claim 1, wherein the user interface is operable to generate a first control input to the elevating mechanism to elevate the litter frame at a first speed, when used in combination with a second control input to the elevating mechanism, the first control input and the second control input changing the elevation of the litter frame to a second speed greater than the first speed.

4. The patient support according to claim 1, wherein the user interface includes a variable control mechanism, the variable control mechanism varying the elevating mechanism speed based on variation of the input at the user interface.

5. The patient support according to claim 1, wherein the bearings comprise wheels.

6. The patient support according to claim 1, further comprising a base, the base supporting the bearings.

7. A patient support comprising:
bearings;
a litter frame supported relative to the bearings;
an elevating mechanism for changing the elevation of the litter frame relative to the bearings, the elevating mechanism changing the elevation of the litter frame at an elevating mechanism speed;
a sensor configured to detecting when the cot is in a loading/unloading area of a conveyance apparatus; and
a controller in communication with the sensor, the controller configured to control the elevating mechanism speed based on input from the sensor.

8. The patient support according to claim 7, wherein the sensor comprises an RFID reader, a proximity sensor, a hall sensor or a reed sensor.

9. The patient support according to claim 7, wherein the sensor is supported by the litter frame.

10. The patient support according to claim 9, wherein the litter frame includes a load wheel, and the sensor is coupled to the load wheel and is configured to detect when the load wheel is in contact with the conveyance apparatus.

11. The patient support according to claim 7, wherein the litter frame includes a safety bar, the sensor being coupled to the safety bar and being configured to detect when the safety bar is engaged at the conveyance apparatus.

12. The patient support according to claim 7, wherein said sensor is configured to detect an interface with or close proximity to a cot fastener or loading system of the conveyance apparatus.

13. A patient support comprising:
bearings;
a litter frame supported relative to the bearings;
an elevating mechanism for changing the elevation of the litter frame relative to the bearings;
a sensor configured to detect vertical motion of the bearings, the litter frame, or the elevating mechanism; and
a controller in communication with the sensor, the controller configured to operate the elevating mechanism at a selected speed based on input from the sensor.

14. The patient support according to claim 13, wherein the controller changes the speed of the elevating mechanism when the sensor detects vertical motion of the litter frame.

15. The patient support according to claim 13, wherein the sensor is an accelerometer.

16. A patient support comprising:
bearings;
a litter frame supported relative to the bearings;
an elevating mechanism for changing the elevation of the litter frame relative to the bearings;
a sensor configured to measure the distance or proximity of the patient support or the litter frame to a reference; and
a controller in communication with the sensor, and the controller configured control the elevating mechanism speed based on input from the sensor.

17. The patient support according to claim 16, wherein the sensor measures the distance of the patient support to a conveyance apparatus.

18. The patient support according to claim 17, wherein the controller is configured to change the elevating mechanism speed when the sensor determines the patient support is in close proximity to conveyance apparatus.

19. The patient support according to claim 16, wherein the sensor measures the distance of the base frame to the ground.

20. The patient support according to claim 19, wherein the controller is configured to change the elevating mechanism speed based on the distance measured by the sensor.

21. The patient support according to any of the above claims, wherein the elevating mechanism exerts a force on the litter deck, and wherein the controller limits the force of the elevating mechanism based on the elevating mechanism speed.

22. A patient support comprising
bearings;
a litter frame supported relative to the bearings;
an elevating mechanism for changing the elevation of the litter frame relative to the bearings at an elevating mechanism speed;
a sensor configured to measure the weight of an occupant on the patient support; and
a controller in communication with the sensor, the controller configured to adjust the elevating mechanism speed based on the weight measured by the sensor.

23. The patient support according to any one of claims 7-22, wherein the bearings comprise wheels.

24. The patient support according to any one of claims 7-22, further comprising a base, the base supporting the bearings.

25. The patient support according to any one of claims 7-22, wherein the sensor comprises an RFID reader, a proximity sensor, a hall sensor or a reed sensor.

26. The patient support according to any above claim, wherein the patient support comprises an emergency cot.

27. A method of controlling the speed of an elevation mechanism of a patient support, said method comprising:
sensing an input or parameter associated with the patient support; and
adjusting the speed of the elevating mechanism based on the sensed parameter.

28. The method according to claim 27, wherein the sensing includes sensing a user input at the patient support.

29. The method according to claim 27, wherein the sensing includes sensing the proximity of the patient support to a conveyance apparatus, such as an ambulance.

30. The method according to claim 27, wherein the sensing includes sensing the weight of an occupant on the patient support.

31. The method according to claim 27, wherein the sensing includes sensing a user input at the patient support.

32. The method according to claim 27, wherein the sensing includes sensing the motion of one or more components of the patient support.

33. A patient support comprising:
base;
a litter frame supported relative to the base;
an elevating mechanism for changing the elevation of the litter frame relative to the base;
a sensor configured to detect vertical motion of the base, the litter frame, or the elevating mechanism; and
a controller in communication with the sensor, the controller configured to operate the elevating mechanism at a selected speed based on input from the sensor.

34. The patient support according to claim 33, wherein the controller changes the speed of the elevating mechanism when the sensor detects vertical motion of the base.

35. The patient support according to claim 34, wherein the sensor is an accelerometer.
